(19) United States
(12) Patent Application Publication
(10) Pub. No.: US 2014/0025428 A1
(43) Pub. Date: Jan. 23, 2014

(54) Deriving Marketing Strategies from Product Utility Value

(71) Applicants: George T. Jacob Sushil, Bangalore (IN); Kalapriya Kannan, Bangalore (IN)

(72) Inventors: George T. Jacob Sushil, Bangalore (IN); Kalapriya Kannan, Bangalore (IN)

(73) Assignee: INTERNATIONAL BUSINESS MACHINES CORPORATION, Armonk, NY (US)

(21) Appl. No.: 13/554,049

(22) Filed: Jul. 20, 2012

(51) Int. Cl. G06Q 30/02

(52) U.S. Cl. 705/7.32

(57) ABSTRACT

Disclosed is a method, system and computer program product for deriving marketing strategy for at least one of a product and a service utility value from an associated utility value by collecting feedback from a user of at least one product or service, wherein the feedback provided by the user is available in multiple sources associated with the at least one product or service, computing a utility value for the at least one product or service based on the feedback of the user, and generating an appropriate marketing strategy for the at least one product or service based on the utility value. Other embodiments are also disclosed.

### BACKGROUND

The utility value of a product or a service is important for deriving various marketing strategies both to the consumers and to the manufacturers/retailers and service providers. Deriving the value for utility of the product or service is time consuming. Such a process involves several parameters such as market acceptance, consumer preference, market trends, competitive products, the decay of the product value, changing trends in technology, changing trends in the requirements, etc. The recent explosive growth of social data has provided opportunities to directly obtain consumer feedback. However, manual processing of the social data to extract all of the above information is time consuming without proper formulation of the relationship between the data and the requirements that determine the product value. Firstly, the set of criteria that determine the product utility value has to be defined. Secondly, for each of these criteria, the consumer expectations, satisfaction, threats, changing trends etc., have to be derived considering social data as the source of input data. Further, along each criteria of the product, an index has to be drawn to determine the relevance of specific feedback to targeted consumers.

### SUMMARY

Embodiments of the invention are broadly related to a method and system for deriving strategies for manufacturers and/or service providers by considering different dimensions of information that impact the product or service acceptance in the market. Some of these considered dimensions include but are not limited to the consumer related data based on weights on which individual consumers are evaluated, product/service performance and acceptance in the market, feedback obtained for the product/service through social content, nature of the individuals contributing to the content, etc. This can be carried out by monitoring a product or service feedback from publically available information, wherein the monitoring includes gathering product or service feedback by searching or crawling on the web, using, for example, techniques such as a keyword search based on the product or service. From the information obtained, an aspect of the invention also includes extracting sentiments or expressions associated with the product or service feedback, analyzing the sentiments or expression associated with the product or service feedback, and based on the associated product or service feedback, determining a utility value for a product or service.

In a further embodiment, the product or service feedback is associated with the features of a product the service provided. In yet a further embodiment, the consumer's preferences for product features or capability or aspects of the service are extracted from consumer data to derive the utility value for its features. The product or service features are given relevant weights by a consumer, or, further, the weights are based on the role/expertise of the person who has provided the feedback. In yet a further embodiment, utility value for the product or service is determined based on the customer or the manufacturer, and the utility values depend on at least one of a current market trend, market acceptance of the product, product value, performance of the product, pricing, and competitor information. Further embodiments include a method that determines or derives the similarity index between consumers based on their product feature preferences, profile information, demographics, etc.

In yet another embodiment, mercantile intelligence guidelines can be input, and content or data which are in accordance with the guidelines are obtained to analyze and create a market intelligence report for the manufacturer or service provider.

Embodiments of the invention can also be related to a method and system for deriving marketing strategy for at least one of a product or a service utility value from an associated utility value by collecting feedback from a user of the at least one product or service, wherein the feedback provided by the user is available in a variety of sources associated with at least one product or a service. Such embodiments also include computing a utility value for the at least one product or service based on the feedback of the user, and based on the utility value, generating an appropriate marketing strategy for the at least one product or service. The variety of sources noted above can include at least one of (i) a metadata source that is a structured data source and/or unstructured data source, and (ii) a repository. Further, the at least one metadata source can include the Internet and/or a data source on a world-wide-web source, and in one embodiment the metadata are provided manually by the user, and in another embodiment the metadata are collected from the Internet and/or the world-wide-web source.

Further embodiments of the invention are related to computing the utility value by categorizing the feedback into a set of parameters based on a pre-defined set of rules, wherein the set of parameters is associated with the at least one product or service. Such embodiments can also include comparing the at least one parameter with parameters associated with at least one product or service in a similar category, and determining a similarity index among users based on the feedback and the at least one set of parameters associated with the at least one product or service. The information associated with a user and corresponding feedback is stored in a repository. The utility value for the at least one product or service based on the feedback of the user can be provided as a ranked list for deriving a marketing strategy. The utility values depend on at least one of a current market trend associated with the product, a market acceptance of the product, a product value, performance of the product, pricing information, and competitor information. The utility values can also depend on at least one of a current market trend associated with the service, a market acceptance of the service, a service value, performance of the service, pricing information, and competitor information.

Reference is made to the accompanying description in conjunction with the drawings and the claimed embodiments of the invention as pointed out in the claims for a better understanding of exemplary embodiments of the invention, together with other features and advantages thereof.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 depicts an exemplary block diagram of a distributed data processing environment in which exemplary aspects of illustrative embodiments may be implemented, the data processing system also being referred to as a general purpose computing system;

FIG. 2 is an exemplary block diagram of a data processing system in which exemplary aspects of illustrative embodiments may be implemented;

FIG. 3 schematically illustrates an exemplary block diagram of system architecture in accordance with the invention disclosed; and

FIG. 4 schematically illustrates an example flow diagram of a process for assigning product utility value and deriving marketing strategies.

### DETAILED DESCRIPTION

It will be readily understood that the components of one or more embodiments of the invention, as generally described and illustrated in the figures herein, may be arranged and designed in a wide variety of different configurations in addition to the described example embodiments. Thus, the following detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art will recognize, however, that the various embodiments of the invention can be practiced without at least one of the specific details, or with other methods, components, materials, etc. In other instances, well-known structures, materials, or operations are not shown or described in detail to avoid obscuring aspects of the invention.

The description now turns to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

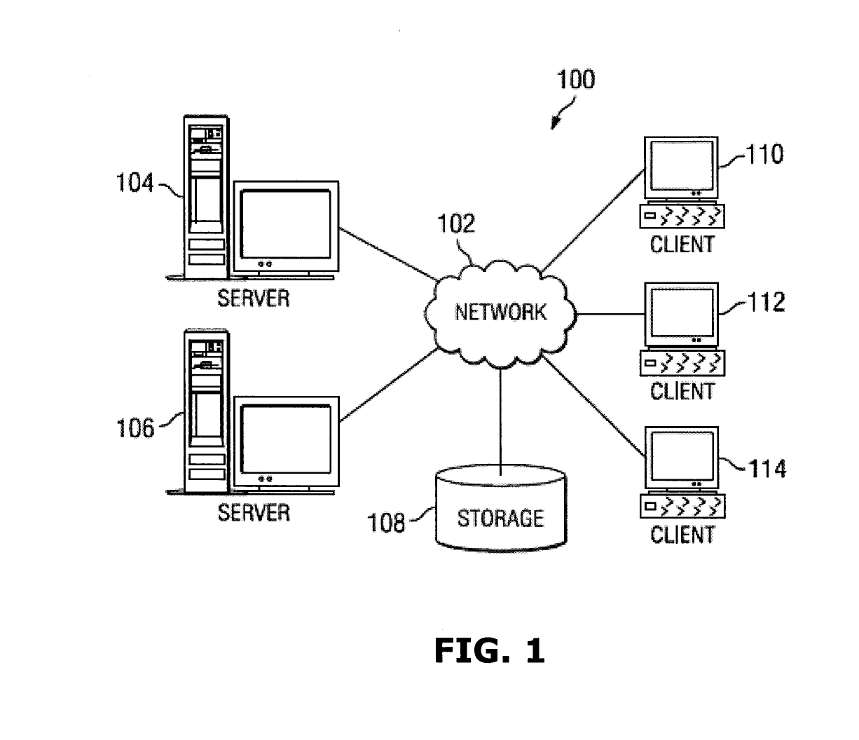

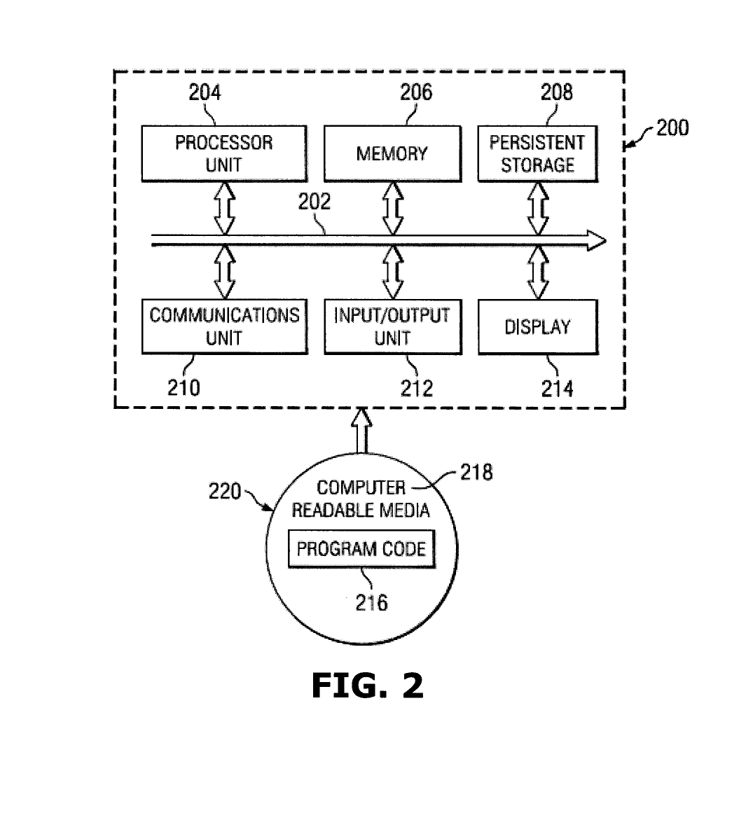

With reference now to the drawings and in particular with reference to FIGS. 1-2, exemplary diagrams of data processing environments are provided in which illustrative embodiments of the disclosure may be implemented. It should be appreciated that FIGS. 1-2 are only examples and are not intended to assert or imply any limitation with regard to the environments in which aspects or embodiments of the disclosed subject matter may be implemented. Many modifications to the depicted environments may be made without departing from the spirit and scope of the present invention.

With reference now to the drawings, FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, including thousands of commercial, governmental, educational and other computer systems that route data and messages. Of course, the distributed data processing system 100 may also be implemented to include a number of different types of networks, such as, for example, an intranet, a local area network (LAN), a wide area network (WAN), or the like. As stated above, FIG. 1 is intended as an example, not as an architectural limitation for different embodiments of the disclosed subject matter, and therefore, the particular elements shown in FIG. 1 should not be considered limiting with regard to the environments in which the illustrative embodiments of the present invention may be implemented.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments. In this example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. In another example embodiment, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For instance, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example embodiment, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Computer program code for carrying out operations of the present invention may be written in any combination of one or more programming languages, including an object-oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the symmetric multiprocessing (SMP) system mentioned previously, without departing from the spirit and scope of the disclosed subject matter.

As will be seen, the techniques described herein may operate in conjunction within the standard client-server paradigm such as illustrated in FIG. 1, in which client machines communicate with an Internet-accessible Web-based portal executing on a set of one or more machines. In such an approach, end users operate Internet-connectable devices (for example, desktop computers, notebook computers, Internet-enabled mobile devices, or the like) that are capable of accessing and interacting with the portal. Typically, each client or server machine is a data processing system such as illustrated in FIG. 2 comprising hardware and software, and these entities communicate with one another over a network, such as the Internet, an intranet, an extranet, a private network, or any other communications medium or link. A data processing system typically includes one or more processors, an operating system, one or more applications, and one or more utilities. The applications on the data processing system provide native support for Web services including, without limitation, support for Hypertext Transfer Protocol (HTTP), Simple Object Access Protocol (SOAP), Extensible Markup Language (XML), Web Services Description Language (WSDL), Universal Description, Discovery and Integration (UDDI), and Web Services Flow Language (WSFL), among others. Information regarding SOAP, WSDL, UDDI and WSFL is available from the World Wide Web Consortium (W3C), which is responsible for developing and maintaining these standards; further information regarding HTTP and XML is available from Internet Engineering Task Force (IETF).

In the alternative, the techniques described herein may operate within a standalone data processing system, or within the context of a “cloud” environment wherein computing resources are shared among a number of entities.

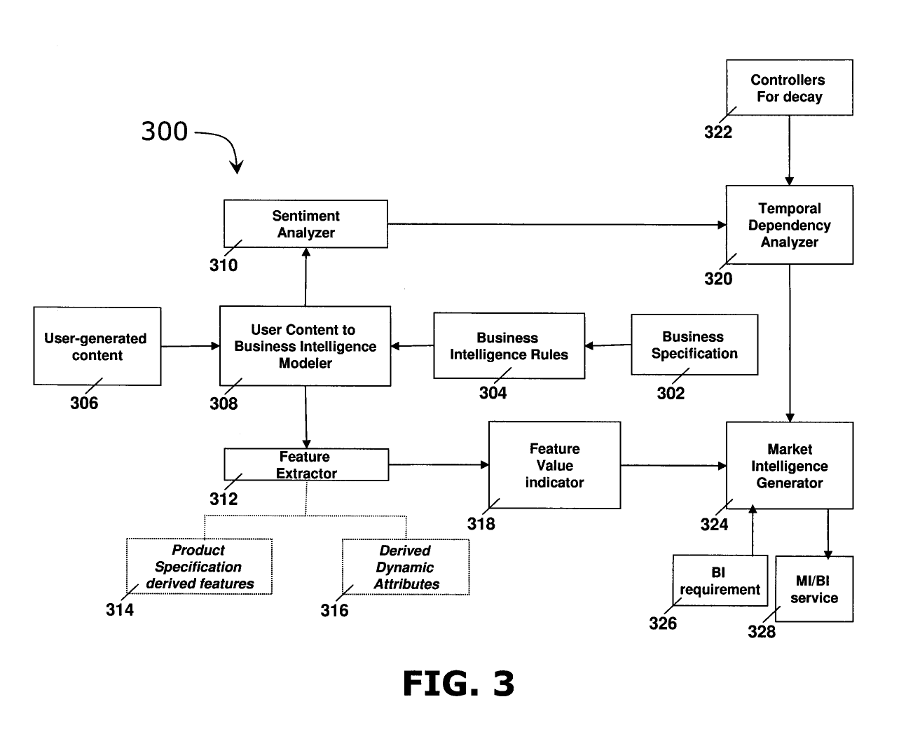

Reference is now made to FIG. 3. It should be appreciated that the processes, arrangements and products broadly illustrated therein can be carried out on or in accordance with essentially any suitable computer system or set of computer systems, which may, by way of an illustrative and non-restrictive example, include a system or server such as that indicated at 100 in FIG. 1. In accordance with an example embodiment, most, if not all of the process steps, components and outputs discussed with respect to FIG. 3, can be performed or utilized by way of a processing unit or units and system memory such as those indicated, respectively in FIGS. 1 and 2, whether on a server computer, a client computer, a node computer in a distributed network, or any combination thereof.

In accordance with at least one embodiment of the invention, there are broadly contemplated herein methods and arrangements for obtaining market intelligence that is publically available, for example via a social media. As such, the growing popularity of publically available information, such as social media, provides for an enormous amount of data being collected through such forums, which represents a viable and promising alternative to conventional efforts. Broadly contemplated herein is a comprehensive framework representing a pluggable mechanism that integrates data from various sources, facilitates analysis of the data for different business intelligence (BI) purposes, and provides a mechanism via which both consumers and manufactures can, on an on-demand basis, consume and make use of both the data and the analyses performed thereupon. Particularly contemplated herein are methods and arrangements via which different sources of data are integrated and several types of BI analyses are performed, such as, for example, market threats, performance trends, consumer expectations, price and revenue predictions, etc. These can be made available to consumers, which can include both manufactures and product/service consumers, on an on-demand basis.

FIG. 3 schematically illustrates example system architecture in accordance with at least one embodiment of the invention. A business intelligence specification 302 is provided in advance for deriving formal rules 304 for expressing business intelligence (BI) 304. Particularly, such rules 304 indicate and convey predetermined requirements and expectations for the quantitative analysis of BI. User-generated content 306 serves as another input, and it can be understood that deriving BI based on the user content 306 involves analysis of guidance provided by the rules 304 for expectations of what is to be determined from the user content 306. By way of illustrative and non-restrictive examples, such expectations can involve ascertaining product performance, general product facts, consumer expectations, features that predominate in customer discussions of a product, and sentiments associated with any or all of such parameters, or more. A modeler of user content to BI (308) generates a map that relates the BI terms to social content terms or generally can be referred to also as publically available information or content. “Terms” here are mentioned in a linguistic sense, in consideration of differing sets of terms being used to indicate performance metrics in a BI context and a social content context, respectively. As such, a map can encompass a simple mapping of terms from BI specifications to content in social data to provide information or guidance on what type of information from social content would need to be looked for in deriving BI.

In accordance with at least one embodiment of the invention, a sentiment analyzer 310 and feature extractor 312 are configured, respectively, for extracting those sentiments and features that directly contribute to BI. Feature extractor 312 can be guided to ascertain different types of features, such as those derived from product specifications (314) or attributes derived dynamically (316). Dynamically derived attributes 316, for their part, can arise from a great variety of scenarios or events. For instance, information on the service of a product might not be provided by the manufacturer and thus could be derived dynamically as consumers provide information through social content. Service quality, as such, can be looked upon as one of those attributes that consumers often request but are not readily available from the manufacturer or retailer, and thus may need to be dynamically derived as social content comes through, if derived at all. Other examples of dynamically derived attributes can include the quality of reception or battery life of a mobile phone, as ascertained from users' experience, etc.

Further, in accordance with at least one embodiment of the invention, the prevalence and importance of features are measured via statistical analysis with a feature value indicator (318). Further, extracted sentiments are mapped to an assessment value during the duration of the active period of the life cycle of the product, via employing a temporal dependency analyzer 320, which in a separate embodiment also takes into account controllers for product-related decay 322. In the context of embodiments of the invention, there is a wide variety of possible algorithms or arrangements for suitably mapping extracted sentiments to an assessment value or product utility value.

In accordance with at least one embodiment of the invention, a market intelligence (MI) generator 324 accommodates a given business intelligence requirement 326 (for example, as accommodated on an as-needed or ad-hoc basis), such as price prediction and performance trends, and performs an analysis which can be made available to an end-consumer as a management information (MI) or BI service 328.

In accordance with at least one exemplary embodiment of the invention, and by way of an illustrative and non-restrictive example, FIG. 3 also is a process for assigning product utility value, as this can represent a feature value as discussed heretofore. User generated content, such as user reviews (as might appear in comments on a social network, for instance), are determined and the relative importance of product features is ascertained. As such, a rule is applied to arrange the features in the order of the importance for each product, by use of a weight W calculated as a function of opinions (for example, the number of positive opinions obtained versus the number of negative opinions obtained) for a product feature divided by the total number of opinions on the product feature. Accordingly, features are extracted by querying a catalog system, and as part of this, for each feature, opinions are extracted. W is derived based on a principle that the importance of a feature is reflected by the amount of “noise” that it creates in the user generated content.

In accordance with an example embodiment, assigning product utility values includes consideration of factors including opinions expressed over time, an exponential component for modeling the natural decay of a value of the product during its lifetime, and wherein controllers for decay can be employed, as indicated, at 322 in FIG. 3. Also, factors can also include important features of the product, as relatively valued by consumers. The expected attribute utility value of attribute K of the product j at time t is expressed by the equation:

U_{k,j}^{r}(t)=aₖ+bₖ∫_{I=0}¹exp^{-rI}p_{jk,j}(x,t)dx.

Product utility value is then calculated using the equation:

$${U}_{j}^{T} ( t ) = {\sum }_{k ∈ \{ 1 , 2 , … , K \}}^{ } ω k {U}_{k , j}^{T} ( t ) ,$$

as a weighted sum of expected attribute utility values (EAUVs). By way of illustrating the usefulness of these calculations, for example, a prior product feature utility value can be considered to be analogous to brand value, deriving utility value over time.

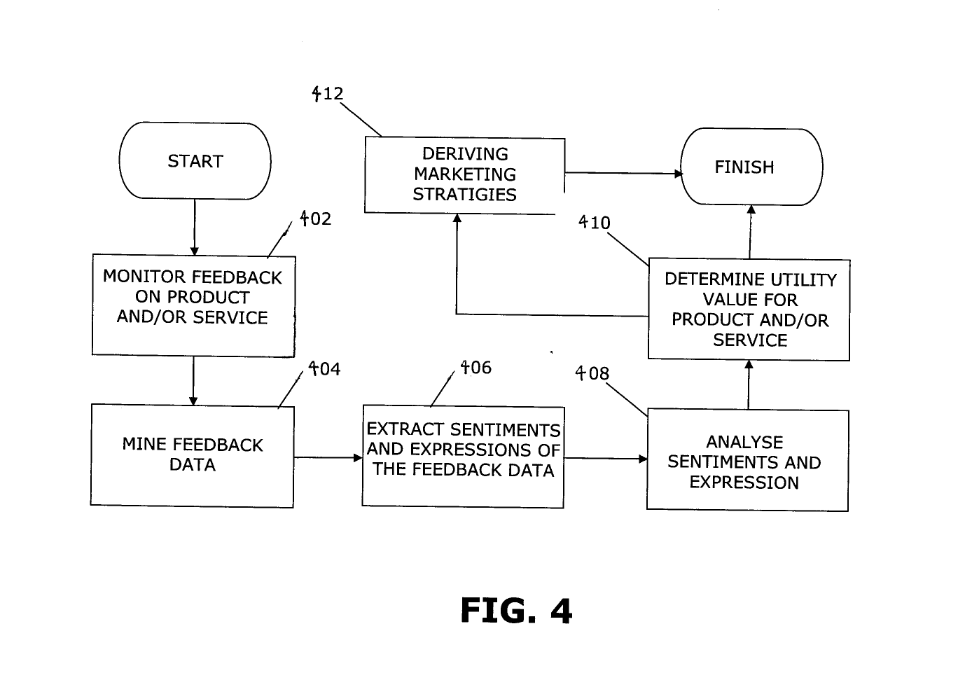

FIG. 4 sets forth a process more generally for deriving strategies using information gathered from market intelligence, in accordance with at least one embodiment of the invention. It should be appreciated that a process such as that broadly illustrated in FIG. 4 can be carried out on essentially any suitable computer system or set of computer systems, which may, by way of an illustrative and non-restrictive example, include a system such as that indicated in FIGS. 1 and 2. In accordance with an example embodiment, most if not all of the steps discussed with respect to FIG. 4 can be performed by way a processing unit or units and system memory such as those indicated, respectively in FIGS. 1 and 2. As shown in FIG. 4, guidelines for deriving strategies from the mercantile intelligence are first obtained by monitoring feedback (402) regarding a service or product that is publically available or provided to the manufacturer or service provider through any other means. The feedback data being large is then mined (404) for specifics. In one embodiment, such classification for mining may be provided by the manufacturer or the service provider.

From the content/data all sentiments and expressions expressed by the user in the feedback are extracted (406), and an analysis can be performed on the extracted data (408), and, for example, a lookup table mapping the feedback to any relevant inputs provided by the manufacturer or provider may be created. A utility value for the product or service is generated from the feedback (410), and this utility value can be used to create reports from which new strategies can be derived (412), where these new strategies will facilitate a better product or service to the user in general.

This may be made applicable using cloud computing as well, wherein cloud computing is one example of a suitable cloud computing node and is not intended to suggest any limitation as to the scope of use or functionality of embodiments of the invention described herein. Regardless, a cloud computing node is capable of being implemented and/or performing any of the functionality set forth hereinabove. In accordance with embodiments of the invention, a computing node may not necessarily even be part of a cloud network, but instead could be part of another type of distributed or other network, or could represent a stand-alone node. For the purposes of discussion and illustration, however, node is variously referred to herein as a “cloud computing node” which can comprise a computer as illustrated in FIG. 1.

Aspects of the invention are described herein with reference to flow chart illustrations and/or block diagrams of methods, apparatus (system) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

1. A method for deriving marketing strategy for a product or a service utility value from an associated utility value, the method comprising:
collecting feedback from a user of at least one product or service over a period of time, wherein the feedback provided by the user is available in multiple sources associated with the at least one product or service, and wherein said collecting is carried out via a module executing on a hardware processor;
computing a utility value for the at least one product or service based on (i) the feedback of the user expressed over the period of time and (ii) a model expressing decay of value of the at least one product or service over the period of time, wherein said computing is carried out via a module executing on a hardware processor; and
generating a strategy for modifying the at least one product or service based on mapping the utility value to (i) performance of the at least one product or service in the market, (ii) one or more trends in the market, and (iii) information pertaining to at least one product or service of a competitor, wherein said generating is carried out via a module executing on a hardware processor.

2. The method as claimed in claim 1, wherein the sources comprise at least one metadata source.

3. The method as claimed in claim 2, wherein the at least one metadata source is selected from a structured data source, an unstructured data source and a repository.

4. The method as claimed in claim 2, wherein the at least one metadata source is at least one of the Internet and a data source on a world-wide-web source.

5. (canceled)

6. The method as claimed in claim 2, wherein the at least one metadata source comprises the user.

7. The method as claimed in claim 1, wherein computing the utility value comprises:
categorizing the feedback into a set of parameters based on a pre-defined set of rules, wherein the set of parameters is associated with the at least one product or service;
comparing the set of parameters based on a pre-defined set of rules with a set of parameters associated with at least one product or service in a similar category; and
determining a similarity index among users based on the feedback and the set of parameters associated with the at least one product or service.

8. The method as claimed in claim 1, wherein information associated with the user and corresponding feedback is stored in a repository.

9. The method as claimed in claim 1, wherein the utility value for the at least one product or service based on the feedback of the user is provided as a ranked list for deriving the marketing strategy.

10. The method as claimed in claim 1, wherein the utility values depend on at least one of a current market trend associated with the at least one product or service, a market acceptance of the at least one product or service, a product value, performance of the at least one product or service, pricing information and competitor information.

11. (canceled)

12. A system, comprising: a memory unit for storing a computer program for deriving marketing strategy for a product or a service from an associated utility value; and a processor coupled to said memory unit, wherein said processor, responsive to said computer program is configured to:
collecting feedback from a user of at least one product or service over a period of time, wherein the feedback provided by the user is available in multiple sources associated with the at least one product or service;
computing a utility value for the at least one product or service based on (i) the feedback of the user expressed over the period of time and (ii) a model expressing decay of value of the at least one product or service over the period of time; and
generating a strategy for modifying the at least one product or service based on mapping the utility value to (i) performance of the at least one product or service, in the market, one or mere trends in the market, and (iii) information pertaining to at least one product or service of a competitor.

13. The system as claimed in claim 12, wherein the sources comprise at least one metadata source.

14. The system as claimed in claim 13, wherein the at least one metadata source is selected from a structured data source, an unstructured data source and a repository.

15. The system as claimed in claim 13, wherein the at least one metadata source is at least one of the Internet and a data source on a world-wide-web source.

16. (canceled)

17. The system as claimed in claim 13, wherein the at least one metadata source comprises the user.

18. The system as claimed in claim 12, wherein computing the utility value comprises:
categorizing the feedback into a set of parameters based on a pre-defined set of rules, wherein the set of parameters is associated with the at least one product or service;
comparing the set of parameters based on a pre-defined set of rules with a set of parameters associated with at least one product or service in a similar category; and
determining a similarity index among users based on the feedback and the set of parameters associated with the at least one product or service.

19. The system as claimed in claim 12, wherein information associated with the user and corresponding feedback is stored in a repository.

20. The system as claimed in claim 12, wherein the utility value for the at least one product or service based on the feedback of the user is provided as a ranked list for deriving the marketing strategy.

21. The system as claimed in claim 12, wherein the utility values depend on at least one of a current market trend associated with the at least one product or service, a market acceptance of the at least one product or service, a product value or performance of the at least one product or service, pricing information and competitor information.

22. (canceled)

23. A computer program product embodied in a computer readable storage medium for deriving marketing strategy for at least one of a product or a service from an associated utility value, the computer program product comprising the programming instructions for:
collecting feedback from a user of at least one product or service over a period of time, wherein the feedback provided by the user is available in multiple sources associated with the at least one product or service;
computing a utility value for the at least one product or service based on (i) the feedback of the user expressed over the period of time and (ii) a model expressing decay of value of the at least one product or service over the period of time; and
generating a strategy for modifying the at least one product or service based on mapping the utility value to (i) performance of the at least one product or service in the market; (ii) one or more trends in the market, and (iii) information pertaining to at least one product or service of a competitor.
